(19) United States
(12) Patent Application Publication
(10) Pub. No.: US 2026/0250791 A1
(43) Pub. Date: Aug. 27, 2026

(54) A PROCESS FOR PRODUCING IRON OXIDE PELLETS

(71) Applicant: IRON ORE COMPANY OF CANADA, Montréal (CA)

(72) Inventors: Blair KELLY, Labrador City (CA); Kaeim SELIM, Labrador City (CA); Jim THOMPSON, Senneville (CA)

(21) Appl. No.: 18/872,531

(22) PCT Filed: Jul. 19, 2024
(86) PCT No.: PCT/CA2024/050957

§ 371 Date: Dec. 6, 2024

Related U.S. Application Data
(60) Provisional application No. 63/514,915, filed on Jul. 21, 2023.

(51) Int. Cl. C21B 13/00; C01G 49/02; C22B 1/24; C22B 1/243; C22B 1/244

(52) U.S. Cl. CPC C21B 13/0046; C01G 49/02; C22B 1/2406; C22B 1/243; C22B 1/244; C01P 2006/90; C21B 2200/00

(57) ABSTRACT

There is provided a method of producing iron oxide pellets having a target internal energy measured as a target heat of magnetite equivalent (HME). Direct reduced iron (DRI) or reduced iron (RI) is obtained as a by-product of iron and steel making. The DRI is mixed with iron ore, a binder, other mineral additives, and a carbon material such as coke breeze. The iron ore comprises hematite and/or magnetite and/or goethite. The DRI is present in a concentration of at least 1 wt. % and the carbon material is present in the mixture in a concentration of from 0 to 0.8 wt. %. The mixture contains sufficient amount of DRI to maintain the target HME calculated as follows:

target HME=CV of CM/CV of mag (wt. % of CM)+wt. % of mag+CV of DRI/CV of mag (wt. % of DRI)

CV=calorific value and CM=carbon material.

The iron oxide pellets are then formed from the mixture, dried and subjected to an induration process.

### CROSS-REFERENCE TO A RELATED APPLICATION

This disclosure claims priority from U.S. Provisional Application No. 63/514,915 filed Jul. 21, 2023, which is incorporated herein by reference in its entirety.

### TECHNICAL FIELD

This disclosure relates to the field of iron oxide pellets and methods of making same.

### BACKGROUND OF THE ART

Iron oxide pellets (or pellets), referred to as greenballs before they are dried and indurated, are produced in a generally spherical form (5-20 mm of diameter) by rolling finely ground iron ore with suitable additives and a binder. Pellets are utilized as feedstock for direct reduction (DR) or blast furnace (BF) iron making operations. To obtain sufficient internal energy to facilitate the induration of a greenball into a pellet of acceptable quality, coke breeze is traditionally included in the greenball mix. The inclusion of coke breeze leads to a significant production of carbon dioxide during the formation of the pellet, particularly at the induration step. Accordingly, improvements in the pelletizing process are desired, particularly a reduction in the production of carbon dioxide while maintaining sufficient internal energy in the iron oxide pellets.

### SUMMARY

In one aspect, there is provided a method of producing iron oxide pellets having a target internal energy measured as a target heat of magnetite equivalent (HME). The method includes receiving direct reduced iron (DRI) obtained as a by-product of iron and steel making. The DRI is mixed with iron ore, a binder, and a carbon material. The iron ore contains hematite and/or magnetite and/or goethite. The DRI is present in a concentration of at least 1 wt. %, and the carbon material is present in the mixture in a concentration of from 0 to 0.8 wt. %. The mixture contains a sufficient amount of DRI iron to maintain the target HME calculated as follows:

$$target HME = \frac{CV of CM}{CV of mag} ( wt . \% of CM ) + wt . \% of mag + \frac{CV of DRI}{CV of mag} ( wt . \% of DRI )$$

where CV stands for calorific value and CM stands for carbon material. The iron oxide pellets are formed from the mixture, dried and subjected to an induration process.

In some embodiments, the target HME is calculated as follows:

$$target HME = \frac{CV of CM}{0.495 \frac{MJ}{kg}} ( wt . \% of CM ) + wt . \% of magnetite + \frac{CV of DRI}{0.495 \frac{MJ}{kg}} ( wt . \% of DRI ) .$$

In some embodiments, the calorific value of DRI is calculated as follows:

$$\frac{( wt . \% of magnetite * 495 \frac{kJ}{kg} ) + ( wt . \% of wustite * 2051 \frac{kJ}{kg} ) + ( wt . \% of metallic iron * 7360 \frac{kJ}{kg} ) + ( wt . \% of total carbon * 32800 \frac{kJ}{kg} )}{{10}^{5}}$$

In some embodiments, the concentration of the carbon material in the mixture is less than 0.1 wt. %. In some embodiments, the concentration of the DRI is of at least 2 wt. %. In some embodiments, the DRI comprises magnetite and/or wustite and/or iron metal. In some embodiments, the DRI particles have a size of less than 2 mm. In some embodiments, the mixing comprises grinding and/or ball milling. In some embodiments, the method further comprises, after the mixing and before the forming, breaking lumps in the mixture. In some embodiments, the method further comprises, before the forming, filtering the mixture to exclude particles larger than 200 μm. In some embodiments, the binder is bentonite and/or an organic binder. In some embodiments, the mixture further comprises an additive selected from limestone and dolomite. In some embodiments, the concentration of magnetite in the mixture is from 10 to 80 wt. %. In some embodiments, the mixture is in the form of a slurry. In some embodiments, the mixture further comprises determining the composition of the DRI received and determining the calorific value of the DRI. In some embodiments, the carbon material is selected from the group consisting of coke breeze, anthracite, biomass and combinations thereof.

There is also provided an iron oxide pellet obtained or obtainable from the method of the present disclosure.

Many further features and combinations thereof concerning the present improvements will appear to those skilled in the art following a reading of the instant disclosure.

### DESCRIPTION OF THE DRAWINGS

FIG. 1A is a graph of the abrasion index in function of the grate factor for pellets produced with carbon (condition referred to herein as “reference”).

FIG. 1B is a graph of the cold compression strength (CCS) in function of the grate factor for pellets produced with carbon.

FIG. 2A is a graph of the abrasion index in function of the grate factor for pellets produced with DRI sludge replacing coke breeze.

FIG. 2B is a graph of the cold compression strength (CCS) in function of the grate factor for pellets produced with DRI sludge replacing coke breeze.

FIG. 3A is a graph of the max grate factor in function of the heat of magnetite equivalent (HME).

FIG. 3B is a graph of the abrasion index in function of HME.

FIG. 4 is a graph showing the CO₂ emissions in function of HME.

FIG. 5A is a graph of the cold compression strength (CCS) in function of the grate factor.

FIG. 5B is a graph of the maximal temperature interface in function of the grate factor.

FIG. 6 is a graph showing the CO₂ emissions in function of HME obtained from a second experiment.

### DETAILED DESCRIPTION

The present disclosure provides the use of an iron based substitute for carbon materials (i.e. coke breeze, anthracite and/or biomass) in the production of iron oxide pellets. The term “biomass” as used herein refers to the charcoal-like material obtained by burning organic matter such as biowaste from the agriculture or forestry industries. In some embodiments, the term biomass can be defined as consisting of carbon and ashes. The term “coke breeze”, in some embodiments, refers to the residue obtained from the screening of heat treated coke, and has a size of less than one-half inch. The addition of the iron based substitute allows to reduce or eliminate the concentration of carbon materials in iron oxide pellets and to reduce the resulting CO₂ emissions while maintaining a target internal energy of the iron oxide pellets. Depending on the pellets' chemical and mineralogical composition, the target internal energy will vary.

Iron oxide pellets are produced by mixing iron ore with a binder and optionally additives. Traditionally, after selecting the target internal energy, an amount of carbon material such as coke breeze is added in the mixture to have the resulting iron oxide pellets reach the target internal energy. However, this addition of carbon material (e.g. coke breeze) leads to undesirable CO₂ emissions during the pelletizing process. To reduce or eliminate the carbon content, direct reduced iron (DRI) which includes magnetite and/or wustite and/or iron metal is provided instead of the carbon material (e.g. coke breeze).

Traditionally, coke breeze is included in the mixture in a concentration of 1.1 to 1.6 wt. % (e.g. about 1.4 wt. %). The use of the DRI allows for the reduction of coke breeze concentration to up to 0.8 wt. %, up to 0.7 wt. %, up to 0.6 wt. %, up to 0.5 wt. %, up to 0.4 wt. %, up to 0.3 wt. %, up to 0.2 wt. % or to less than 0.1 wt. %. In some embodiments, no coke breeze is added in the mixture and therefore the DRI completely replaces the coke breeze. More generally when considering carbon materials, reference can be made to the carbon concentration rather than the coke breeze concentration. Accordingly, the concentration of elemental carbon in the mixture is up to up to 0.8 wt. %, up to 0.7 wt. %, up to 0.6 wt. %, up to 0.5 wt. %, up to 0.4 wt. %, up to 0.3 wt. %, up to 0.2 wt. % or to less than 0.1 wt. %. To achieve the reduction in coke breeze content, the DRI is included in the mixture in a concentration of at least 1 wt. %, at least 1.5 wt. %, at least 2 wt. %, from 1 to 12 wt. %, from 2 to 10 wt. %, or from 3 to 8 wt. %.

One of the factors affecting the variability in concentration for the additions of DRI and optionally coke breeze is the variability in the compositions of iron ore and DRI. DRI is a by-product of steel making and therefore does not have a consistent composition by virtue of being a by-product. The composition of DRI will vary based on the composition of the iron ore used and different mines produce different iron ore contents, and will vary based on the operating strategy, quality targets, feedstock composition, direct reduction technology, and overall efficiency of the DRI producers. Generally, DRI by-products contain a total Fe metal content of at least 60 wt. % and/or a total Fe element content of at least 80%. DRI may comprise other compounds such as but not limited to SiO₂, Al₂O₃, MgO, CaO, Na₂O, K₂O, TiO₂, MnO, P₂O₅, Cr₂O₃, V₂O₅, ZrO₂, ZnO and graphite. DRI may be characterized by a particle size of less than 2 mm.

The iron ore as used herein contains hematite and magnetite and can contain goethite. The target internal energy for the iron oxide pellets is calculated as a target heat of magnetite equivalent (HME). The equation is as follows:

$$target HME = \frac{CV of CM}{CV of mag} ( wt . \% of CM ) + wt . \% of mag + \frac{CV of DRI}{CV of mag} ( wt . \% of DRI )$$

Where CM=carbon material, CV=calorific value, and mag=magnetite, or alternatively when the carbon material is coke breeze

$$target HME = \frac{CV of coke}{CV of mag} ( wt . \% of coke ) + wt . \% of mag + \frac{CV of DRI}{CV of mag} ( wt . \% of DRI )$$

The equation is such that when the wt. % of carbon material or coke breeze is 0, the concentration of DRI is increased to maintain the target HME at the same value or in some cases the HME can be increased. The concentration of magnetite is in the range of from 10 to 80 wt. % to obtain a useful iron pellet, and in some cases in the range of 30 to 50 wt. % or 35 to 45 wt. %. The calorific values of coke breeze, magnetite, wustite, and metallic iron are measurable values that may not necessarily be constant. In some embodiments, the calorific value of magnetite is from 490 MJ/kg to 520 MJ/kg or about 495 MJ/kg. In some embodiments, the calorific value of wustite is from 2040 to 2060 MJ/kg or about 2051 MJ/kg, and the caloric value of metallic iron is from 7350 to 7370 kJ/kg or about 7360 kJ/kg. The calorific value of DRI can be calculated as follows:

$$\frac{( wt . \% of mag * CV of mag ) + ( wt . \% of wus * CV of wus ) + ( wt . \% of {Fe}_{metal} * CV of {Fe}_{metal} ) + ( wt . \% of total carbon * CV of carbon )}{{10}^{5}}$$

where CV=calorific value, wus=wustite and mag=magnetite

In some embodiments, the equation can be simplified as follows:

$$\frac{( wt . \% of magnetite * 495 \frac{kJ}{kg} ) + ( wt . \% of wustite * 2051 \frac{kJ}{kg} ) + ( wt . \% of metallic iron * 7360 \frac{kJ}{kg} ) + ( wt . \% of total carbon * 32800 \frac{kJ}{kg} )}{{10}^{5}}$$

In some embodiments, in order to calculate the CV of DRI as per the two equations above, the composition of DRI is analyzed to determine the concentrations of magnetite, wustite, metallic iron and the total carbon content. In other embodiments, the composition analysis may not be a necessary step if the DRI is from a known source with known concentrations or if the steel making plant has already performed an analysis of the DRI.

In the process of making iron oxide pellets, the mixture is kept as a slurry and dewatered before the agglomeration step where a binder is added. Examples of binders that can be included in the dewatered mixture are bentonite and/or organic binders (that are substitutes to bentonite). These organic binders include a variety of carbon-based polymeric or fibrous compounds. Limestone and/or dolomite are optional additives that can be included in the mixture and additives that can be processed by grinding and/or ball milling, for example wet ball milling. Optionally, after the grinding and/or ball milling, the mixture can be treated so as to break the lumps formed (if any). Filtration is used to remove the water from the slurry mixture.

The pellets are formed by shaping into spherical shapes (i.e. the material is agglomerated into green balls). Preferably, the mixture is first filtered to exclude particles larger than 200 μm. The balls formed are then conveyed to be subjected to the induration process. Induration is a process of drying and firing (cooking), and cooling the pellets. The induration process can be subdivided into steps of calcination, combustion, fusion, and oxidation of the various compounds with the objective of achieving target physical and metallurgical properties. The final product is fired pellets, and the off gases during the induration process are exhausted through a stack on each induration machine.

The use of coke breeze is the largest emitter of CO₂ equivalent at the Iron Ore Company (IOC) of Canada. The coke breeze is used as an internal energy source in iron ore pelletizing which contributes to enhancing product quality and reducing fuel consumption (i.e. heavy fuel oil) which completes the iron ore induration process. Iron oxide pellets require thermal energy to complete all the necessary drying, calcination, combustion, fusion, and sintering reactions. This is completed with a combination of carbon based fuels and exothermic reactions. The present disclosure replaces at least a portion of the traditional carbon materials such as coke breeze with DRI in order to reduce the CO₂ emissions while maintaining similar properties for the pellets. The DRI provides the thermal energy required while reducing or avoiding CO₂ emissions without diluting the iron content of the iron oxide pellets.

### Example 1

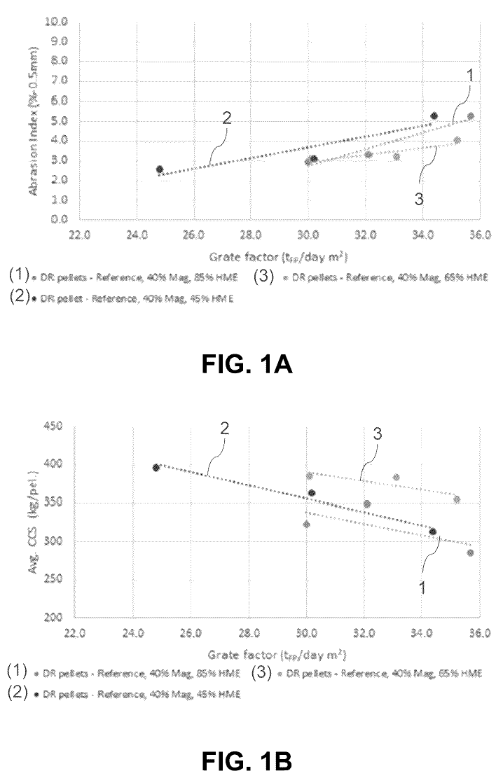

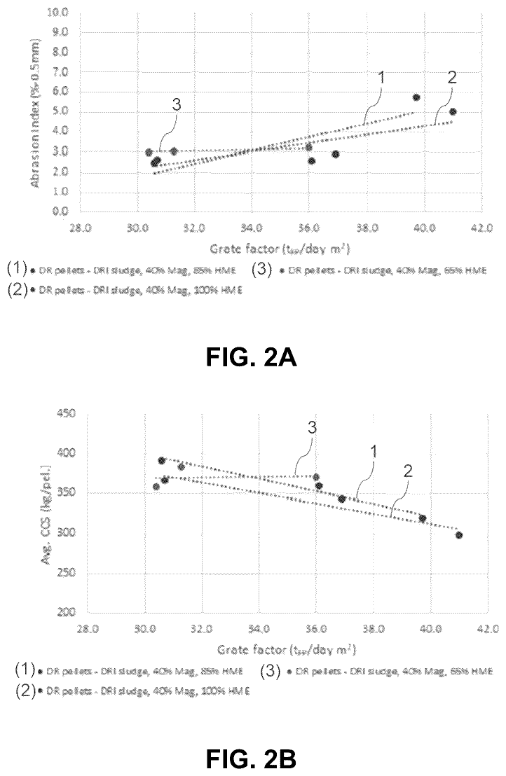

Pellets were obtained by mixing the components present in table 1 (see below) with water. The mixture was then subjected to lump breaking and ball milling with water (1 m diameter). After ball milling, a roller screen (−16.0+9.5 mm) was used to reduce the particle size before subjecting the feed to a pot grate (0.1 m²) for sampling and testing. The DRI sludge that was used in the present example was characterized (Tables 2 and 3) before use and it was found to have a calorific value of 5.2 MJ/kg. A higher grate factor was achieved with a higher magnetite concentration while having similar pellet quality. Increasing the grate factor while keeping the same firing conditions increased the abrasion index and decreased the cold crushing strength (CCS) and the maximum interface temperature (FIGS. 1A-1B and 2A-2B). This assessment was made for constant firing conditions (temperature, gas flow, and bed depth) where the interface between the fresh bed and the hearth layer is maintained at 2350° F. (i.e. the interface layer) by adjusting the grate factor. It was also observed that specific surface area (Blaine) increased as magnetite increased. Moreover, higher grate factor was achieved with a higher % HME, while having similar abrasion (FIGS. 1A-1B and 2A-2B). No significant negative impact on pellet quality was observed when replacing coke breeze with DRI.

TABLE 1
Pot-grade test on pellet feed with and without carbon addition
to evaluate the impact on the fired pellets quality and
productivity (concentrations provided in weight percent)

| | Fix carbon | Magnetite | DRI sludge | HME |
|---|---|---|---|---|
| | (%) | (%) | (%) | (%) |
| Without | 0.0 | 25 | 0.0 | 25 |
| carbon | 0.0 | 45 | 0.0 | 45 |
| | 0.0 | 65 | 0.0 | 65 |
| | 0.0 | 85 | 0.0 | 85 |
| With coke | 1.0 | 40 | 0.0 | 85 |
| breeze | 0.6 | 40 | 0.0 | 65 |
| | 0.1 | 40 | 0.0 | 45 |
| With DRI | 0.0 | 40 | 4.4 | 85 |
| sludge | 0.0 | 40 | 2.5 | 65 |
| | 0.0 | 40 | 5.9 | 100 |

TABLE 2
Particle size of DRI as received

Fraction

| μm | mesh | Cumulative passing (%) |
|---|---|---|
| 212 | 65 | 12.9 |
| 150 | 100 | 6.8 |
| 106 | 150 | 3.4 |
| 75 | 200 | 2.1 |
| 53 | 270 | 1.0 |
| 45 | 325 | 0.8 |

TABLE 3
Composition of the DRI sludge as received

| Chemical | Composition (%) |
|---|---|
| % SiO₂ | 2.5 |
| % Feₜₒₜ | 85.2 |
| % MgO | 0.4 |
| % CaO | 1.03 |
| % MnO | 0.13 |
| % FeO | 108 |
| % Feₘₑₜ | 62.5 |
| % Sₜₒₜ | 0.02 |
| % Cₜₒₜ | 0.86 |
| % C_{graph} | 0.24 |

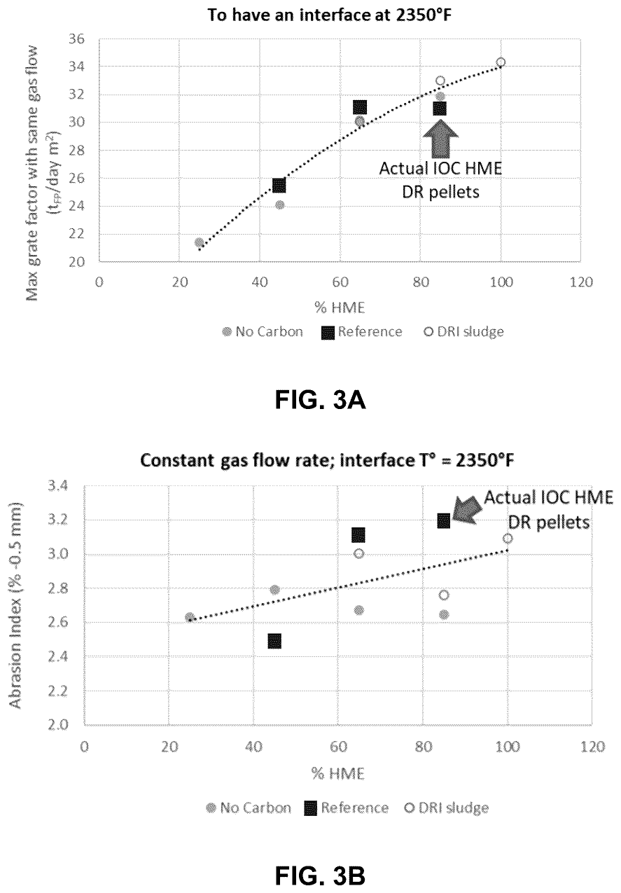

A lower HME results in a lower productivity and is a risk to product quality. If the actual coke breeze addition is removed from the pellet feed, while maintaining the actual typical level of magnetite at 40%, a significant decrease of 25% in productivity was estimated (FIG. 3A). At 85% HME a similar productivity can be achieved. Lower HME with DRI fines resulted in slightly higher pellet quality (abrasion and CCS, FIG. 3B). Thus, a decrease of pellet physical properties should not be expected if the actual coke breeze addition is removed from the pellet feed. At 85% HME, a slightly better abrasion index was achieved with magnetite and DRI sludge.

This Example demonstrated that removing coke breeze without maintaining internal energy (i.e. the condition without carbon) the following occurred:
a significant decrease of 25% in productivity was estimated if magnetite is maintained at 40 wt. %,
no negative impact on pellet quality,
a significant increase in burner fuel rate of 76% as well as a total thermal energy (burners and internal energy) increase of 6%, and
a decrease of 14% in CO₂ emission is estimated (kg CO₂/t_{FP} basis) (the 25% decrease in productivity should however be noted).

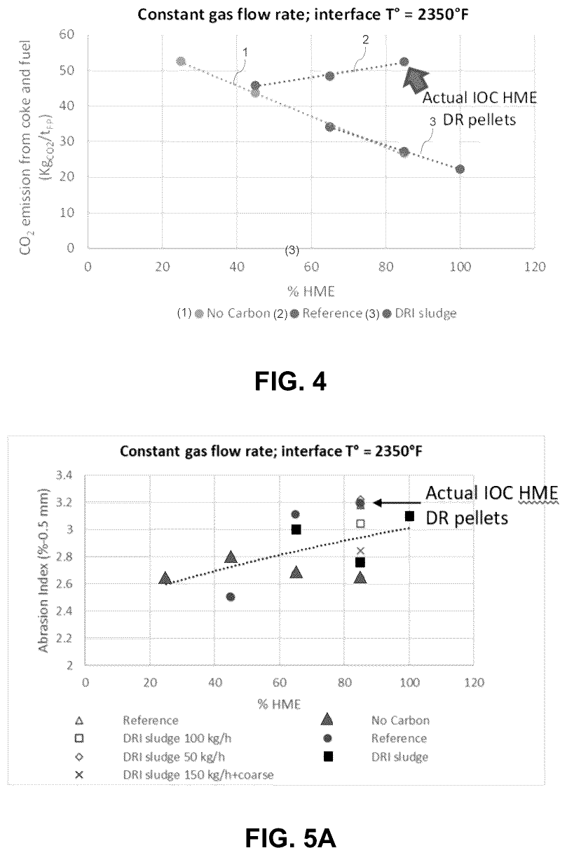

This Example demonstrated that by replacing coke breeze with DRI sludge, the following was achieved:
a similar productivity was observed,
a slightly better abrasion index was achieved with magnetite and the DRI sludge addition (FIG. 3A),
an improved CCS was achieved with DRI sludge (FIG. 3B),
similar energy from the burner was observed (data not shown), and
lower CO₂ emission was achieved with magnetite and DRI sludge (−49%) (FIG. 4).

### Example 2

Another DRI sludge (Table 4) was used in this Example. DRI sludge sampling was taken throughout the ball milling process and after grinding. DRI sludge was found to be coarser after drying.

TABLE 4
Composition of the DRI sludge as received

| Chemical | DRI Sample 1 | DRI Sample 2? |
|---|---|---|
| % Feₜₒₜ | 85.2 | 84 |
| % FeO | 108 | 108 |
| % Feₘₑₜ | 62.5 | 57.7 |
| % Cₜₒₜ | 0.86 | 0.93 |
| % Satmagan | >100 | >100 |
| % SiO₂ | 2.5 | 1.61 |
| % Al₂O₃ | 0.3 | 0.51 |
| % CaO | 1.03 | 1.21 |
| % MgO | 0.4 | 0.36 |
| % LOI | −27.0 | −27.0 |
| % Fe³⁺ | 1.0 | 0.1 |
| % Fe²⁺ | 21.4 | 26.2 |
| % estimated hematite | 0 | 0 |
| % estimated | 2 | 0 |
| magnetite | | |
| % estimated wustite | 28 | 34 |
| % estimated metallic | 63 | 56 |
| iron | | |
| % total | 97.1 | 96.2 |
| O/Fe* | 0.27 | 0.31 |
| % reduction | 82.0 | 79.1 |
| Calorific value | 5.46 | 5.24 |

The calorific values were calculated as follows and are presented in Table 5.

$$calorific value [ \frac{MJ}{kg} ] = \frac{( ( \% Mag . * \frac{495 kJ}{kg} ) ( \% Wus . * 2051 \frac{kJ}{k g} ) + ( \% {Fe}_{m e {t}^{*}} \frac{7 \; 360 kg}{kg} ) + ( \% {C}_{t o t} * \frac{32 \; 800 kJ}{k g} ) )}{( 100 * 1000 )}$$

### Simplification:

$$\frac{Δ {H}_{C - c a r b o n}}{Δ {H}_{C - m a g n e t i t e}} = \frac{\frac{3 2.8 MJ}{kg}}{\frac{0.4 \; 95 MJ}{kg}} = 66.3$$

$$HME ( \% ) = 66.3 \% C + \% Magnetite$$

### Actual HME of Coke Breeze:

$$HME ( \% ) = \frac{cal . value of coke}{0.495} * \frac{\% {C}_{P e l l e t F e e d} * 100}{\% {C}_{c o k e}} + \% Magnetite = 95 \%$$

### The HME Formula Therefore Becomes:

$$HME ( \% ) = \frac{cal . value of coke}{0.495} \% C o k e + \% Magnetite + \frac{cal . value of DRI}{0.495} \% DRI$$

$$Where$$

$$DRI cal . value = \frac{( \% Mag . * 495 \frac{kJ}{k g} ) + ( \% Wus * \frac{2 \; 051 kJ}{k g} ) + ( \% {Fe}_{m e {t}^{*}} \frac{7 \; 360 kJ}{k g} ) + ( \% {C}_{t o t} * \frac{328 \; 000 kJ}{k g} )}{100 * 1000}$$

### Which can be Simplified to the Following in the Present Example:

$$HME ( \% ) = 54.9 * \% C o k e + \% Magnetite + 10.6 * \% DRI$$

TABLE 5
Calorific value comparison between the inclusion
of coke breeze and its replacement with DRI

| | | | With DRI as coke breeze | |
|---|---|---|---|---|
| | With coke breeze | | replacement | |
| | | Enthalpy | | Enthalpy |
| Component | Filter feed (%) | (MJ/Kg) | Filter feed (%) | (MJ/Kg) |
| Ore blend | 97.6 | 0 | 94.3 | 0 |
| Magnetite | 40.2 | 0.495 | 39.1 | 0.495 |
| Bentonite | 0.9 | 0 | 0.8 | 0 |
| Dolomite | 0.0 | −1.521 | 0.0 | −1.521 |
| Limestone | 0.6 | −1.784 | 0.6 | −1.784 |
| Coke | 1.0 | 27.2 | — | — |
| DRI sludge | — | — | 4.3 | 5.24 |
| Total energy of | 0.462 MJ/kg total feed | | 0.411 MJ/kg total feed | |
| pellet (HME = | | | | |
| 85%) | | | | |

A pot grate test was performed with one reference condition with carbon (i.e. 1 wt. % coke breeze) and three experimental conditions with 4.6 wt. % of DPI instead of the coke breeze (Table 6). The Satmagan result in the pellet feed was higher in pellets with DPI sludge compared to those with carbon (Table 6). This is due to the metallic Fe present in DPI sludge. A comparison was performed between pellets during firing in the induration process and the fire pellets obtained (Table 7). It was found that the R180, DR90, and linder of pellets with DPI sludge is comparable to the reference pellets containing coke breeze.

TABLE 6
Pellet and green ball characteristics

| | | | | | DR pellets - No | | | DR pellets - No | | | DR pellets - No | | |
|---|---|---|---|---|---|---|---|---|---|---|---|---|---|
| | | DR pellets - | | | carbon but with DRI | | | carbon but with DRI | | | carbon but with DRI | | |
| | | Reference with | | | sludge, 40% | | | sludge, 40% | | | sludge, 40% | | |
| | | carbon, | | | Mag, 85% HME | | | Mag, 85% HME | | | Mag, 85% HME | | |
| | | 40% Mag, 85% HME | | | 40% Mag and 4.6% | | | 40% Mag and 4.6% | | | 40% Mag and 4.4% | | |
| | | 40% Mag and 1% | | | DRI sludge in the pellet | | | DRI sludge in the pellet | | | DRI sludge in the pellet | | |
| | | coke breeze in the | | | feed, 100 kg/h | | | feed, 50 kg/h | | | feed, 150 kg/h | | |
| | | pellet feed | | | throughput | | | throughput | | | throughput | | |
| | | 1.2% SiO₂ | | | 1.2% SiO₂ | | | 1.19% SiO₂ | | | 1.19% SiO₂ | | |
| | | 0.70% CaO, 0.21% | | | 0.70% CaO, 0.21% | | | 0.70% CaO, 0.21% | | | 0.70% CaO, 0.23% | | |
| | | MgO | | | MgO | | | MgO | | | MgO | | |
| DESCRIPTION | | CaO/SiO₂ = 0.59 | | | CaO/SiO₂ = 0.59 | | | CaO/SiO₂ = 0.59 | | | CaO/SiO₂ = 0.60 | | |
| PELLET | HME | 85 | | | 85 | | | 85 | | | 85 | | |
| FEED | % −325M/ | 73.3/88.3 | | | 71.1/86.1 | | | 71.2/86.8 | | | 71.2/86.1 | | |
| | % −200M | | | | | | | | | | | | |
| | BLAINE | 1844 | | | 1767 | | | 1781 | | | N/A | | |
| | (cm2/g) | | | | | | | | | | | | |
| | Calculated | 40.2 | | | 39.1 | | | 39.1 | | | 40.6 | | |
| | Magnetite | | | | | | | | | | | | |
| | (%) | | | | | | | | | | | | |
| | SATMAGAN | 39.2 | | | 44.2 | | | 44.4 | | | 51.5 | | |
| | (%) | | | | | | | | | | | | |
| GREEN | % H₂O (AT | 9.0 | | | 8.8 | | | 8.7 | | | 8.9 | | |
| BALLS | BALLING) | | | | | | | | | | | | |
| | % H₂O (POT | 8.9 | 8.9 | 8.9 | 8.8 | 8.8 | 8.8 | 8.8 | 8.7 | 8.6 | 8.8 | 8.9 | 8.8 |
| | LOADING) | | | | | | | | | | | | |

TABLE 7
Pot grate test performed during firing and on the fired pellet

| | | | DR pellets - Reference with | | | DR pellets - No carbon but with | | | DR pellets - No carbon but with DRI | | |
|---|---|---|---|---|---|---|---|---|---|---|---|
| | | | carbon, 40% Mag, | | | DRI sludge, 40% Mag, | | | sludge, 40% Mag, | | |
| | | | 85% HME | | | 85% HME | | | 85% HME | | |
| | | | 40% Mag and 1% coke breeze in | | | 40% Mag and 4.6% DRI sludge in | | | 40% Mag and 4.6% DRI sludge in | | |
| | | | the pellet feed | | | the pellet feed, 100 kg/h throughput | | | the pellet feed, 50 kg/h throughput | | |
| | | | 1.2% SiO₂ | | | 1.2% SiO₂ | | | 1.19% SiO2 | | |
| | | | 0.70% CaO, 0.21% MgO | | | 0.70% CaO, 0.21% MgO | | | 0.70% CaO, 0.21% MgO | | |
| DESCRIPTION | | | CaO/SiO₂ = 0.59 | | | CaO/SiO₂ = 0.59 | | | CaO/SiO₂ = 0.59 | | |
| FIRED | TUMBLE | % +6.3 mm | 96.5 | 96.0 | 96.4 | 96.4 | 95.6 | 97.0 | 96.4 | 95.9 | N/A |
| PELLETS | ISO | % −0.5 mm | 3.1 | 3.5 | 3.2 | 3.2 | 4.0 | 2.6 | 3.2 | 3.7 | N/A |
| | STRENGTH | AVRG | 388 | 325 | 331 | 457 | 352 | 395 | 402 | 368 | N/A |
| | (kg/pel) | | | | | | | | | | |

### IOCC=Iron Ore Company of Canada

R180 and DR90 are ISO tests
Linder=reduction disintegration test

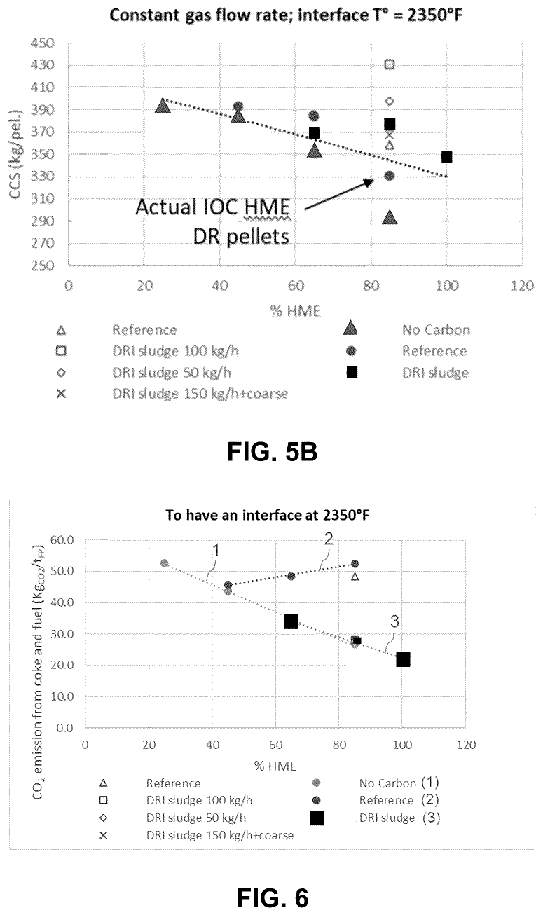

As shown in FIGS. 5A-5B a similar productivity, a similar abrasion index, and a higher CCS was achieved by maintaining the same HME in pellet with DRI sludge compared to the reference produced with coke breeze. The pellets were then provided to a burner to compare the total thermal energy. Similar energies from the burner and similar total thermal energy were observed with pellets with DRI sludge replacing coke breeze. The different size distribution did not impact the energy consumption of the pellets. The resulting CO₂ emissions from the burners was estimated and is presented in FIG. 6. As can be seen in FIG. 6, replacing coke breeze with DRI sludge significantly reduces the CO₂ emissions.

1. A method of producing iron oxide pellets having a target internal energy measured as a target heat of magnetite equivalent (HME), the method comprising:
receiving direct reduced iron (DRI) obtained as a by-product of iron and steel making;
mixing the DRI with iron ore, a binder, and a carbon material, wherein the iron ore comprises hematite and/or magnetite, wherein the DRI is present in a concentration of at least 1 wt. %, wherein the carbon material is present in the mixture in a concentration of from 0 to 0.8 wt. %, and wherein the mixture contains a sufficient amount of DRI to maintain the target HME calculated as follows:
$$target HME = \frac{CV of CM}{CV of mag} ( wt . \% of CM ) + wt . \% of mag + \frac{CV of DRI}{CV of mag} ( wt . \% of DRI )$$
wherein CV stands for calorific value and CM stands for the carbon material;
forming iron oxide pellets from the mixture;
drying the iron oxide pellets; and
subjecting the iron oxide pellets to an induration process.

2. The method of claim 1, wherein the target HME is calculated as follows:
$$target HME = \frac{CV of CM}{0.495 \frac{MJ}{kg}} ( wt . \% of CM ) + wt . \% of magnetite + \frac{CV of DRI}{0.495 \frac{MJ}{kg}} ( wt . \% of DRI ) .$$

3. The method of claim 1, wherein the calorific value of DRI is calculated as follows:
$$\frac{( wt . \% of magnetite * 495 \frac{kJ}{kg} ) + ( wt . \% of wustite * 2051 \frac{kJ}{kg} ) + ( wt . \% of metallic iron * 7360 \frac{kJ}{kg} ) + ( wt . \% of total carbon * 32800 \frac{kJ}{kg} )}{{10}^{5}} .$$

4. The method of claim 1, wherein the concentration of the carbon material in the mixture is less than 0.1 wt. %.

5. The method of claim 1, wherein the concentration of the DRI is of at least 2 wt. %.

6. The method of claim 1, wherein the DRI comprises magnetite and/or wustite.

7. The method of claim 1, wherein the DRI particles have a size of less than 2 mm.

8. The method of claim 1, wherein the mixing comprises grinding and/or ball milling.

9. The method of claim 1, further comprising, after the mixing and before the forming, breaking lumps in the mixture.

10. The method of claim 1, further comprising, before the forming, filtering the mixture to exclude particles larger than 200 μm.

11. The method of claim 1, wherein the binder is bentonite and/or an organic binder.

12. The method of claim 1, wherein the mixture further comprises an additive selected from limestone and dolomite.

13. The method of claim 1, wherein the concentration of magnetite in the mixture is from 10 to 80 wt. %.

14. The method of claim 1, wherein the mixture is in the form of a slurry.

15. The method of claim 1, further comprising determining the composition of the DRI received and determining the calorific value of the DRI.

16. The method claim 1, wherein the carbon material is selected from the group consisting of coke breeze, anthracite, biomass and combinations thereof.

17. An iron oxide pellet produced by the method of claim 1.
